(19) United States
(12) Patent Application Publication
(10) Pub. No.: US 2004/0118664 A1
(43) Pub. Date: Jun. 24, 2004

(54) Multifunction switch and method of using same

(75) Inventors: Todd L. DePue, Brighton, MI (US); Christopher D. Spielman, Redford, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/324,562

(22) Filed: Dec. 19, 2002

(51) Int. Cl. H01H 9/00

(52) U.S. Cl. 200/4

(57) ABSTRACT

A multifunction switch is used to scroll through a set of system modes, such as ambient temperature and radio volume. The switch can also be used to choose a particular system mode from the set of system modes. The same switch can then be used to adjust a parameter associated with the system mode, for example, adjusting the volume level (parameter) of the radio volume (system mode). The multifunction switch includes a switch body for actuating the switch. The switch also includes a display portion for displaying system mode information.

### BACKGROUND OF THE INVENTION

1. Field of the Invention

The present invention relates to a multifunction switch.

2. Background Art

The use of electronic equipment and devices that require some type of electronic control is becoming increasingly prevalent. This trend is apparent in many fields today, including automotive design. The proliferation of electronically controlled systems presents special challenges to an automobile designer, not the least of which is the limited space available in a vehicle passenger compartment. In addition to the electronic controls themselves—e.g., knobs and buttons—there is also a need for display screens to convey information about the various electronic systems. Thus, the need to advantageously arrange all of the electronic controls and displays is increasingly at odds with the need to provide an aesthetically pleasing appearance in the vehicle passenger compartment.

Attempts have been made to reconcile these conflicting goals, in some cases by reducing the number of controls and displays so that aesthetics are not sacrificed for functionality. Toward this end, a number of functions can be incorporated into a single control button, and/or a single display may be configured to convey information about a number of different systems. For example, U.S. patent application Pub. Ser. No. 20010,052,912, published on Dec. 20, 2001, and filed by Ishii et al., describes a multifunction switch with a display function incorporated therein.

Specifically, Ishii et al. describes a series of operation buttons that are used to choose a particular system, such as an air conditioning system or an audio system. In addition, Ishii describes the use of a series of multifunction switches that are used to choose a particular device within a given system. For example, a compact disc player or miniature disc player can be chosen from a set of available audio systems. The multifunction switches can also be used to adjust various parameters associated with a particular device. For example, if the audio system is chosen, and the AM radio is chosen from the set of available audio devices, the multifunction switch can be used to adjust the AM frequency. The multifunction switches, which are pushbutton actuated, include a display used to convey information about which of the systems are chosen, and/or which of the devices are in use.

One limitation of the Ishii et al. switch device is its reliance on two sets of buttons: one to choose a system, and a second to choose a device or adjust a parameter. Although the multifunction switches may allow for the selection of a particular device and the adjustment of a parameter associated with that device, a separate set of control buttons are required to select a particular system. In addition, Ishii et al. teaches the use of “seesaw” switches which require a user to repeatedly press the switch to choose different options. This type of switch may be less convenient than other types of switches, for example, a switch controlled by a rotating knob, which can be configured to easily scroll through a series of devices, or adjust a chosen parameter.

Thus, there still exists a need for a multifunction switch that can be used to eliminate the need for a separate switch for each system, as well as a switch for each electronic device or adjustable parameter. In addition, there is a need for such a switch to incorporate a display function, thereby further reducing the space required in the vehicle passenger compartment. It is also desirable that such a multifunction switch have a rotatable control knob to facilitate convenient scrolling through various selectable options.

### SUMMARY OF THE INVENTION

Under the invention, a multifunction switch for choosing a system mode and for selectively adjusting a parameter associated with a chosen system mode is provided. The multifunction switch comprises a switch body, at least a portion of which is configured to rotate about an axis to actuate the switch in a first manner. The switch body is configured to actuate the switch in a second manner different from the first manner. A display portion is disposed on the switch body for displaying system mode information.

Another aspect of the invention provides a multifunction switch for choosing a system mode and for selectively adjusting a parameter associated with a chosen system mode. The multifunction switch comprises a display portion and a switch body having the display portion disposed thereon. The switch body is configured to actuate the switch in a first manner to display a system mode in the display portion. The switch body is further configured to actuate the switch in a second manner, different from the first manner, to choose the system mode displayed in the display portion. The switch body is also configured to actuate the switch to effect adjustment of a parameter associated with the chosen system mode.

Yet another aspect of the invention provides a method of using a multifunction switch for choosing a system mode and for selectively adjusting a parameter associated with the chosen system mode. The method comprises actuating the switch a first time to display a system mode in a display portion of the switch. The method further comprises actuating the switch a second time to choose the system mode displayed in the display portion, and actuating the switch a third time to adjust a parameter associated with the chosen system mode.

The above object and other objects, features, and advantages of the present invention are readily apparent from the following detailed description and best mode for carrying out the invention when taken in connection with the accompanying drawings.

### BRIEF DESCRIPTION OF THE DRAWINGS

FIG. 1 is a partially fragmentary perspective view of a multifunction switch in accordance with the present invention;

FIG. 2 is a block diagram illustrating the interaction of the switch shown in FIG. 1 with various systems in a vehicle;

FIG. 3 is a front plan view of a portion of the switch shown in FIG. 1, the switch displaying a radio tuning mode;

FIG. 4 is a front plan view of a portion of the switch shown in FIG. 1, the switch displaying a radio volume mode; and

FIG. 5 is a perspective view of an alternative embodiment of the present invention, the switch including a unitary switch body.

### DETAILED DESCRIPTION OF THE PREFERRED EMBODIMENT(S)

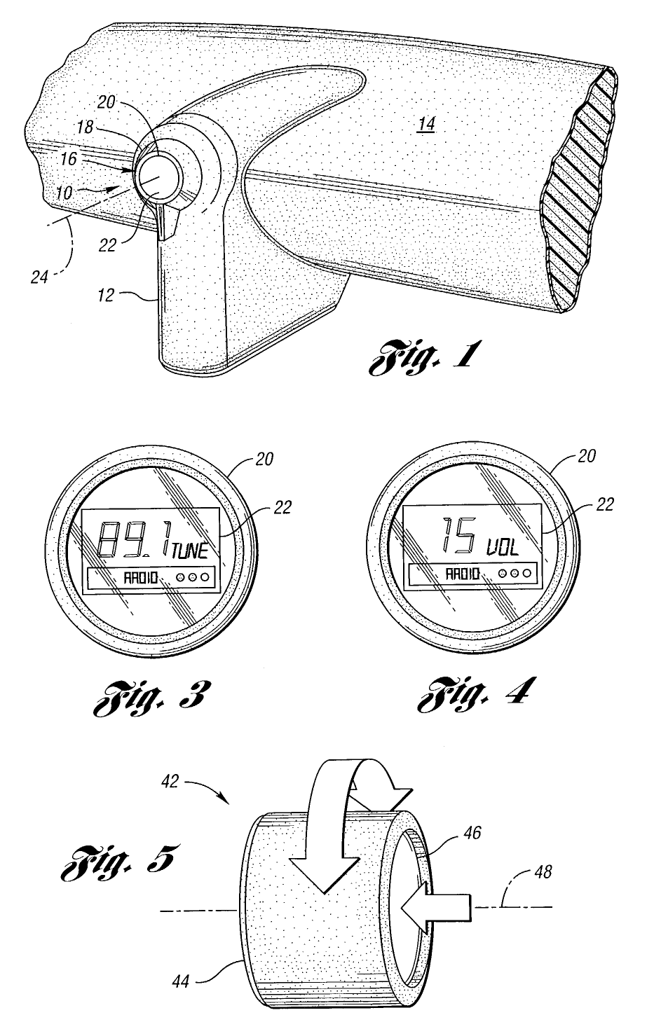

FIG. 1 shows a multifunction switch 10 in accordance with the present invention. The switch 10 may be configured to facilitate control of various systems within a vehicle, such as audio systems, environmental systems, etc. The switch 10 is disposed in a center stack portion 12 of a vehicle instrument panel 14. It is readily apparent that the switch 10 may be conveniently placed in other locations throughout the vehicle passenger compartment. For example, the switch 10 may be located in the instrument panel 14 in close proximity to the driver, rather than in the center of the panel as shown in FIG. 1. Similarly, the switch 10 may be located in any of the consoles—e.g., the center console or the overhead console—or in other locations as desired. Of course, a switch, such as the switch 10, is not limited to use in a vehicle; rather, such a switch may be used virtually anywhere there is a need to combine more than one function into a single switch.

The switch 10 comprises a switch body 16 that includes a first, or outer portion 18 circumferentially disposed around a second, or inner portion 20. The inner portion 20 is generally cylindrical, and is disposed proximate a display portion 22 which displays information relevant to the system or systems to which the switch 10 is connected. In the embodiment shown in FIG. 1, the display portion 22 is disposed on the inner portion 20, and may be considered part of the inner portion 20; however, such a configuration is not required. For example, the display portion 22 need not be physically attached to the inner portion 20. Rather, the display portion 22 could be separately attached to another portion of the switch 10. As explained more fully below, a switch, such as the switch 10, may be connected to various systems through its own controller, or through a central processor, such as a vehicle system controller.

The outer portion 18 is configured to rotate about an axis 24 to actuate the switch 10 in a first manner. In one embodiment of the invention, the inner portion 20 is configured to move linearly along the axis 24 to actuate the switch 10 in a second manner. In another embodiment, the inner portion 20 may be configured with a touch sensitive sensing device—e.g., a capacitive or resistive sensor. In such an embodiment, the switch 10 would be actuated in the second manner by the mere presence of an operator's hand on the inner portion 20, and would therefore not require linear movement of the inner portion 20.

To accommodate repeated use, the switch body 16 may comprise any suitable polymeric material, which may also be used to closely match other components in a vehicle passenger compartment. Alternatively, the switch body 16 may comprise a metallic material to provide even greater strength. The display portion 22 may be covered with a glass or plastic lens to protect the display.

FIG. 2 illustrates a block diagram 26 representing how the switch 10 can be integrated into a vehicle to facilitate control of various systems. Of course, it is readily understood that there are many possible configurations for connecting a switch, such as the switch 10, to various systems, and that FIG. 2 illustrates only one such configuration. Indeed, as noted above, a multifunction switch in accordance with the present invention may be used to facilitate control of multiple systems in a variety of applications, including industrial and other non-vehicular applications.

As illustrated in FIG. 2, control of the various systems within the vehicle is carried out by an electronic control unit (ECU) 28. The ECU 28 may be a vehicle system controller (VSC), or it may be any one of a number of different types of electronic controllers. For example, the ECU 28 may be an application specific integrated circuit (AISC), a programmable integrated circuit (PIC), a system on chip (SOC), or a micro-control unit (MCU). Regardless of the specific type of controller used, the ECU 28 is in electronic communication with the switch 10 and various systems within the vehicle. In the embodiment shown in FIG. 2, for example, the ECU 28 is electrically connected directly to a first switch element or actuator, such as a rotary encoder 30. At least a portion of the rotary encoder 30 is attached to, or integral with, the switch outer portion 18.

The rotary encoder 30 may have any suitable configuration sufficient to effect actuation of the switch 10 in response to rotation of the outer portion 18. For example, the rotary encoder 30 may include a mechanical portion, comprising electrically conductive contacts circumferentially disposed around a surface of the outer portion 18 which interface with stationary contacts on another portion of the switch 10. When the outer portion 18 is rotated, an electronic signal based on the relative position of the interfacing contacts is sent to the ECU 28. The signal indicates the angular position of the outer portion 18.

As another example, the rotary encoder 30 may be an optical encoder which converts the angular position of the outer portion 18 to a digital signal to be sent to the ECU 28. Such an encoder may utilize light through a slotted wheel that rotates when the outer portion 18 is rotated. A photosensitive device could then be configured to detect the interrupted beam of light, and convert this information to a digital signal. Those skilled in the art will recognize that there are other methods by which the angular position of the outer portion 18 could be measured, or otherwise detected, and a signal sent to the ECU 28, and that the examples described above are merely illustrative of two such methods.

As shown in FIG. 2, the switch 10 includes a display controller 32 that may be configured to send information to, and receive information from, the display portion 22. The display controller 32 is in electronic communication with the ECU 28 and the display portion 22; its inclusion may provide additional flexibility in programming the switch 10 to perform the desired functions. It should be noted however, that the display controller 32 is not required. For example, the ECU 28 may be programmed to perform the desired functions. Similarly, the switch 10 is provided with its own internal memory 34, which, like the display controller 32, may be integrated into the ECU 28. When the display controller 32 and the memory 34 are integrated into the ECU 28, a space savings may be realized; however, these components may also be contained in a switch housing or within an instrument panel.

As further illustrated in FIG. 2, the switch 10 may include a second switch element, such as a second switch actuator 36. The second switch actuator 36 may be configured as a push button portion that is attached to, or integral with, the inner portion 20 of the switch body 16. In such a configuration, an operator would push the inner portion 20, moving it linearly along the axis 24, to actuate the switch 10 in the second manner. The second switch actuator 36 would detect the linear movement of the inner portion 20 and send an appropriate signal or signals to the ECU 28.

As described above, the inner portion 20 may be configured with a touch sensitive sensing device, instead of being linearly movable. The second switch actuator 36 may then be configured as a sensing device circuit, capable of receiving signals from the touch sensitive sensing device, and sending an appropriate signal or signals to the ECU 28. Thus, when an operator touches the inner portion 20, the second switch actuator 36 would detect the action, a signal or signals would be sent to the ECU 28, and the switch 10 would be actuated in the second manner.

Like the other elements of the switch 10, the second switch actuator 36 receives power from the vehicle power supply. Because vehicles typically produce power at 12 volts, and because the switch 10 may be configured to operate at a lower voltage, a power conditioning unit 38 may be provided. The power conditioning unit 38 may step down the voltage from 12 volts to a lower voltage such as 5 volts, 3.3 volts, or 2.7 volts. Of course, a power conditioning unit, such as the power conditioning unit 38, may be configured to provide virtually any desired voltage to the switch 10. In addition to stepping-down the voltage to the switch 10, the power conditioning unit 38 also filters motor noise and interference from other sources. This helps to ensure that the switch 10 receives a smooth, constant power signal. As with the display controller 32 and the memory 34, the power conditioning unit 38 may also be integrated into the ECU 28. In such a configuration, the power would be fed directly from the vehicle power supply into the ECU 28, then back out to the switch 10.

The switch 10 communicates with various vehicle systems through the ECU 28. Specifically, the ECU 28 sends and receives signals through a communications hub 40, which is in direct communication with a vehicle bus. The communications hub 40 may be a discrete physical device such as a bus transceiver, configured to send and receive signals to and from the vehicle bus. Conversely, the communications hub 40 may be integrated into the ECU 28, in which case the vehicle bus would be directly connected to the ECU 28. The communications hub 40 can also represent a link to a particular electronic network within the vehicle, such as a local interconnect network (LIN), or a controller area network (CAN).

As briefly discussed above, the switch 10 is configured to be actuated in a first manner and a second manner, which facilitates control of various vehicle systems with only one switch. For example, the switch 10 may be configured such that rotating the outer portion 18 to actuate the switch 10 in the first manner effects a display of a first system mode in the display portion 22. As used here and throughout, the term “system mode” implies a combination of a particular system and a particular parameter associated with the system. For example, a system may be defined as a radio, a compact disc (CD) player, or a heating, ventilating and air conditioning (HVAC) system, just to name a few. Parameters associated with these systems may include tuning (for the radio), selection (for the CD player), and ambient temperature and fan speed (for the HVAC system). Thus, by this definition, system modes would include radio tuning, radio volume, etc. The actual display could be configured with virtually any symbol or text to convey the appropriate system mode.

Of course, defining a system mode as described above, is just one possible way to configure a switch, such as the switch 10. For example, different hierarchal levels of control may be assigned, such that the term “system” is defined at a very high level—e.g., audio or climate control. In a case such as this, the system mode may be radio control (tuning or volume) or HVAC control (temperature or fan speed). With this type of configuration, additional actuation of the multifunction switch may be necessary to choose a particular parameter for adjustment. It is worth noting that this configuration would not necessarily require a change in hardware; rather, it could be programmed into the ECU 28 and/or display controller 32 so that the physical components of the switch 10 need not change.

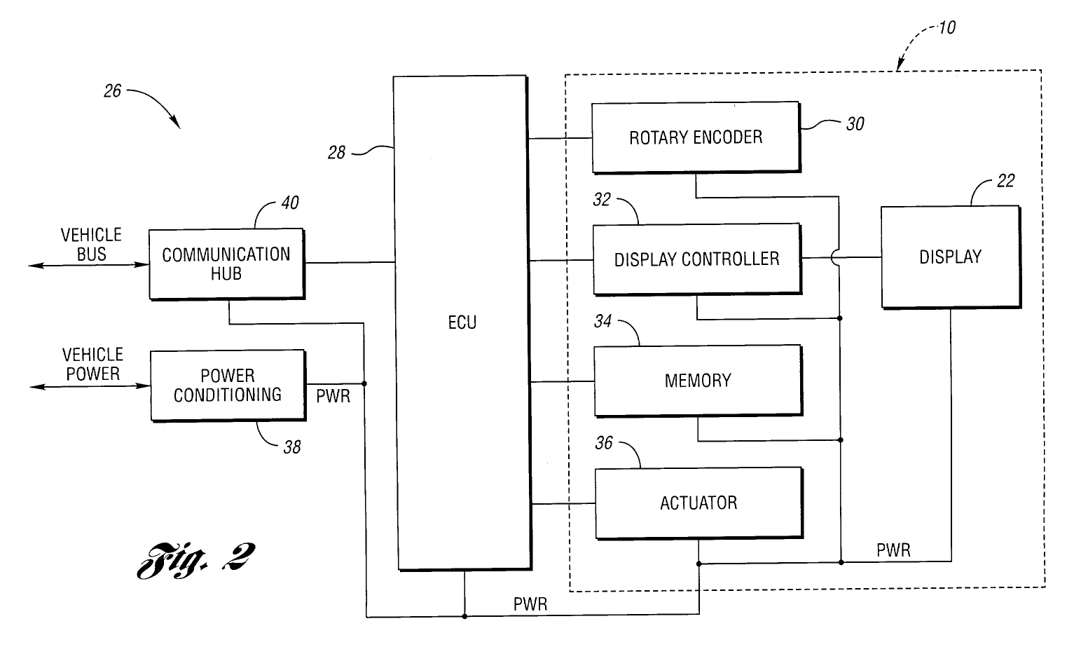

As described above, rotating the outer portion 18 of the switch body 16 to actuate the switch 10 in the first manner, effects a display of a system mode in the display portion 22. For example, FIG. 3 illustrates how a display might appear for a radio tuning mode. Shown in FIG. 3 are the inner portion 20 and the display portion 22 of the switch 10. The display portion 22 is configured with a liquid crystal display (LCD), which may be either passive or active, as desired. In addition, other types of LCD's can be used—e.g., a thin film transistor (TFT) LCD. Of course, the display does not need to be of a liquid crystal type. Examples of non-LCD displays include, but are not limited to, an organic light emitting diode (OLED) and a vacuum fluorescent (VF) display. In addition, as noted above, the display portion 22 can be configured such that the display is symbolic or iconic, as well as textual as shown in FIGS. 3 and 4.

After the switch 10 is actuated a first time by rotating the outer portion 18, repeated or continuous actuation of the switch 10 in the first manner effects a sequential display of system modes in the display portion 22. That is, additional system modes, such as a radio volume mode shown in FIG. 4, are displayed in the display portion 22. Once a system mode is displayed in the display portion 22, the switch 10 can be actuated a second time, and in particular in the second manner, to choose the system mode being displayed. To actuate the switch 10 in the second manner, the inner portion 20 is pushed by an operator to effect linear movement of the inner portion 20 along the axis 24. Of course, if a switch, such as the switch 10, is configured with a touch sensitive sensing device, actuating the switch in the second manner does not require movement of the inner portion 20.

After a system mode has been chosen, actuating the switch a third time, and in particular actuating it in the first manner by rotating the outer portion 18 about the axis 24, effects adjustment of a parameter associated with the chosen system mode. For example, an operator wishing to change the radio frequency would repeatedly or continuously rotate the outer portion 18 of the switch body 16, scrolling through the various system modes until the radio tuning mode was displayed, as shown in FIG. 3. The operator would then push the inner portion 20 along the axis 24 to select the radio tuning mode. Finally, the operator would once again rotate the outer portion 18 to adjust the radio frequency—i.e., the parameter associated with the system mode. A similar sequence would be employed to adjust the radio volume or other parameters on other vehicle systems.

It is important to note that a switch, such as the switch 10, can be configured to suit the needs of a particular application. For example, if desired, the switch could be configured to facilitate adjustment not only of electronic systems—audio and environmental systems—but also of mechanical systems, such as vehicle side mirrors and vehicle seats. Thus, the system modes displayed in the display portion, and therefore the chosen system mode, may be one of a set of system modes that includes: ambient temperature, ventilation fan speed, radio volume, radio tuning, mirror control, and seat position. Such a configuration may increase the complexity of the electronic system required by the switch, but a net space savings may result from the elimination of one or more single function switches. Conversely, the switch may be configured to control only one system, such as an HVAC system. In such a configuration, the switch could be configured to function as described above to facilitate control of temperature and fan speed. Thus, the switch would allow for the choosing of a system mode and the adjustment of a parameter associated with the system mode, but only for a single system.

As described above, the switch body 16 comprises a multi-piece structure including the outer and inner portions 18, 20. FIG. 5 shows an alternative to the multi-piece switch body construction. Specifically, a multifunction switch 42 comprises a switch body 44 that is configured as a generally cylindrical unitary structure. The switch body 44 has a display portion 46 disposed thereon. As indicated by the arrows, the switch 42 can be actuated in a first manner by rotating the switch body 44 around an axis 48. The switch 42 can be actuated in a second manner by moving the switch body 44 linearly along the axis 48, or alternatively, by touching a portion of the switch body 44 if it is configured with a touch sensitive sensing device.

Although the display portion 46 would rotate as the switch body 44 rotates, a controller, such as the ECU 28 or the display controller 32, shown in FIG. 2, can be configured such that the information displayed in the display portion 46 appears to remain horizontal. For example, as the switch body 44 and the display portion 46 are being rotated about the axis 48, the controller could adjust the display on a pixel-by-pixel basis, such that the display appears to remain stationary. If the controller was further configured to refresh the display with a high refresh rate, the pixel-by-pixel adjustment of the display would be almost imperceptible to an operator. In this way, a switch, such as the switch 42, can comprise a rotatable unitary switch body and yet still provide a horizontal display.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A multifunction switch for choosing a system mode, and for selectively adjusting a parameter associated with a chosen system mode, the switch comprising:
a switch body, at least a portion of which is configured to rotate about an axis to actuate the switch in a first manner, the switch body being further configured to actuate the switch in a second manner different from the first manner; and
a display portion disposed on the switch body for displaying system mode information.

2. The multifunction switch of claim 1, wherein rotation of the at least a portion of the switch body about the axis to actuate the switch in the first manner effects display of a first system mode in the display portion.

3. The multifunction switch of claim 2, wherein repeated or continued rotation of the at least a portion of the switch body about the axis repeatedly or continuously actuates the switch in the first manner, thereby effecting display of additional system modes in the display portion.

4. The multifunction switch of claim 3, wherein actuation of the switch in the second manner chooses a system mode displayed in the display portion.

5. The multifunction switch of claim 4, wherein rotation of the at least a portion of the switch body about the axis to actuate the switch in the first manner, after the system mode is chosen, effects adjustment of a parameter associated with the chosen system mode.

6. The multifunction switch of claim 1, wherein at least a portion of the switch body is configured to move linearly along the axis to actuate the switch in the second manner.

7. The multifunction switch of claim 1, wherein the switch body includes a touch sensitive sensing device for actuating the switch in the second manner.

8. The multifunction switch of claim 1, wherein the switch body comprises a multi-piece structure, including a generally cylindrical inner portion and an outer portion circumferentially disposed around the inner portion and rotatable around the axis.

9. A multifunction switch for choosing a system mode, and for selectively adjusting a parameter associated with a chosen system mode, the switch comprising:
a display portion; and
a switch body having the display portion disposed thereon, the switch body being configured to actuate the switch in a first manner to display a system mode in the display portion, the switch body being further configured to actuate the switch in a second manner different from the first manner to choose the system mode displayed in the display portion, and the switch body being further configured to actuate the switch to effect adjustment of a parameter associated with the chosen system mode.

10. The multifunction switch of claim 9, wherein repeated or continued actuation of the switch in the first manner by the switch body effects a sequential display of system modes in the display portion.

11. The multifunction switch of claim 9, wherein the system modes displayed in the display portion include ambient temperature, ventilation fan speed, radio volume, radio tuning, and mirror control.

12. The multifunction switch of claim 9, wherein at least a portion of the switch body is configured to rotate about an axis to actuate the switch in the first manner.

13. The multifunction switch of claim 9, wherein at least a portion of the switch body is configured to move linearly along an axis to actuate the switch in the second manner.

14. The multifunction switch of claim 9, wherein the switch body includes a touch sensitive sensing device for actuating the switch in the second manner.

15. The multifunction switch of claim 14, wherein the touch sensitive sensing device comprises one of a capacitive sensor and a resistive sensor.

16. A method of using a multifunction switch for choosing a system mode, and for selectively adjusting a parameter associated with a chosen system mode, the method comprising:
actuating the switch a first time to display a system mode in a display portion of the switch;
actuating the switch a second time to choose the system mode displayed in the display portion; and
actuating the switch a third time to adjust a parameter associated with the chosen system mode.

17. The method of claim 16, wherein actuating the switch a first time comprises repeatedly or continuously actuating the switch in a first manner to effect a sequential display of system modes in the display portion.

18. The method of claim 16, wherein actuating the switch a first time comprises rotating at least a portion of the switch body to actuate the switch in a first manner.

19. The method of claim 16, wherein actuating the switch a second time comprises linearly moving at least a portion of a switch body along an axis to actuate the switch in a second manner.

20. The method of claim 16, wherein actuating the switch a third time comprises rotating at least a portion of the switch body about an axis to actuate the switch in a first manner after actuating the switch a second time to choose the system mode displayed in the display portion.
